(19) United States
(12) Patent Application Publication
(10) Pub. No.: US 2026/0149854 A1
(43) Pub. Date: May 28, 2026

(54) Content System with Supplemental Audio Content Feature

(71) Applicant: Roku, Inc., San Jose, CA (US)

(72) Inventors: Paul Nangeroni, San Carlos, CA (US); Sheldon Thane Radford, Palo Alto, CA (US)

(21) Appl. No.: 18/959,110

(22) Filed: Nov. 25, 2024

(51) Int. Cl. H04N 21/81; H04N 21/233; H04N 21/25

(52) U.S. Cl. CPC H04N 21/8106; H04N 21/233; H04N 21/251

(57) ABSTRACT

In one aspect, an example method includes: (i) receiving media content comprising video content and audio content; (ii) providing, to a trained machine-learning model, video data associated with the video content; (iii) responsive to the providing, receiving, from the trained machine-learning model, supplemental audio content that was generated by the trained machine-learning model based at least on the provided video data; and (iv) modifying the received media content at least by adding the generated supplemental audio content to the media content.

### USAGE AND TERMINOLOGY

In this disclosure, unless otherwise specified and/or unless the particular context clearly dictates otherwise, the terms “a” or “an” mean at least one, and the term “the” means the at least one.

### SUMMARY

In one aspect, an example method is disclosed. The example method includes: (i) receiving media content comprising video content and audio content; (ii) providing, to a trained machine-learning model, video data associated with the video content; (iii) responsive to the providing, receiving, from the trained machine-learning model, supplemental audio content that was generated by the trained machine-learning model based at least on the provided video data; and (iv) modifying the received media content at least by adding the generated supplemental audio content to the media content.

In another aspect, an example computing system is disclosed. The computing system comprises a processor and a non-transitory computer-readable medium having stored thereon program instructions that upon execution by the processor, cause performance of a set of acts that includes: (i) receiving media content comprising video content and audio content; (ii) providing, to a trained machine-learning model, video data associated with the video content; (iii) responsive to the providing, receiving, from the trained machine-learning model, supplemental audio content that was generated by the trained machine-learning model based at least on the provided video data; and (iv) modifying the received media content at least by adding the generated supplemental audio content to the media content.

In another aspect, an example non-transitory computer-readable medium is disclosed. The computer-readable medium has stored thereon program instructions that upon execution by a computing system, cause performance of a set of acts that includes: (i) receiving media content comprising video content and audio content; (ii) providing, to a trained machine-learning model, video data associated with the video content; (iii) responsive to the providing, receiving, from the trained machine-learning model, supplemental audio content that was generated by the trained machine-learning model based at least on the provided video data; and (iv) modifying the received media content at least by adding the generated supplemental audio content to the media content.

### BRIEF DESCRIPTION OF THE DRAWINGS

FIG. 1 depicts a simplified block diagram of an example content system, in accordance with example embodiments.

FIG. 2 depicts a simplified block diagram of an example computing system, in accordance with example embodiments.

FIG. 3 depicts an example process and logic flow, in accordance with example embodiments.

FIG. 4A depicts media content in a first state, in accordance with example embodiments.

FIG. 4B depicts media content in a second state, in accordance with example embodiments.

FIG. 5 depicts an example method, in accordance with example embodiments.

### DETAILED DESCRIPTION

### I. Overview

Media content can take various forms and can have various attributes. For example, media content can include a video content component and an audio content component. There can be various types of media content. For example, media content can be, or include, a movie, a television show, a commercial or other advertisement content, or a portion or combination thereof, among numerous other possibilities.

Different types of media content can include different types of audio content. For example, a nature documentary film may contain the sounds of nature, background music, and narration in its audio content, while an action movie may include characters'dialogue, background music, and sound effects (e.g., explosions, gunshots, etc.).

An example audio content component of media content could be an audio track, which may have different numbers of audio channels depending on the audio format. For example, the audio content may include one channel (mono audio), two channels (stereo audio), or higher numbers of channels, such as five or seven (sometimes called “surround sound”). In some audio formats, such as Dolby Atmos and DTS: X, further channels may be included for more immersive audio experiences.

In some cases, the audio content component of the media content may not be adequately complete or robust in view of the corresponding video component of the media content. As one example, the audio content could be lacking certain sound effects that may pair well with the video content. In some cases, media content may not always take advantage of the technical capabilities of the content-presentation device that the media content is presented on. For example, a movie with a stereo audio track being presented on a seven-channel surround sound system could result in the stereo channels being duplicated on each of three left and three right speakers, respectively, as opposed to a dedicated audio mix that takes full advantage of the surround sound capabilities. Additionally, the audio content component of the media content may not reflect the preferences or desires of a user. For instance, a user may desire more immersive audio or audio that better reflects the type of content they may be watching.

Disclosed herein are systems and corresponding methods that help address these and other technical problems. According to one aspect of the disclosure, a content manager can (i) receive media content including video content and audio content; (ii) provide, to a trained machine-learning model, video data associated with the video content; (iii) responsive to the providing, receive, from the trained machine-learning model, supplemental audio content that was generated by the trained machine-learning model based at least on the provided video data; and (iv) modify the received media content at least by adding the generated supplemental audio content to the media content.

By applying this technique, the media content can be modified to include audio content that is contextually relevant to and has been generated specifically for the video content, which provides for a more immersive user experience when the media content is being presented. Such audio content may be referred to as “supplemental audio content.” For example, consider a scenario where media content includes (i) video content that depicts a scene of an action movie, and audio content that includes a corresponding stereo audio track. In one example implementation, a content manager can provide video data representing a portion of the video content to a trained machine-learning model, which can use such video data to generate supplemental audio content for the scene, where the supplemental audio content includes sound effects that were not present in the original audio content.

The content manager can then modify the media content such that it includes that generated supplemental audio (e.g., by way of adding that supplemental audio content to the existing stereo audio track by employing any audio adding/summing technique now known or later discovered, or perhaps by combining the original audio content and the generated supplemental audio content together and adding that combined audio content as a new surround sound audio track). Then, when the media content is presented via a content-presentation device, the device can present both the video content and the generated supplemental audio content, thus providing for an improved user experience.

These features, along with other related features, and corresponding example architecture and example operations, will now be described in greater detail.

### II. Example Architecture

### A. Content System

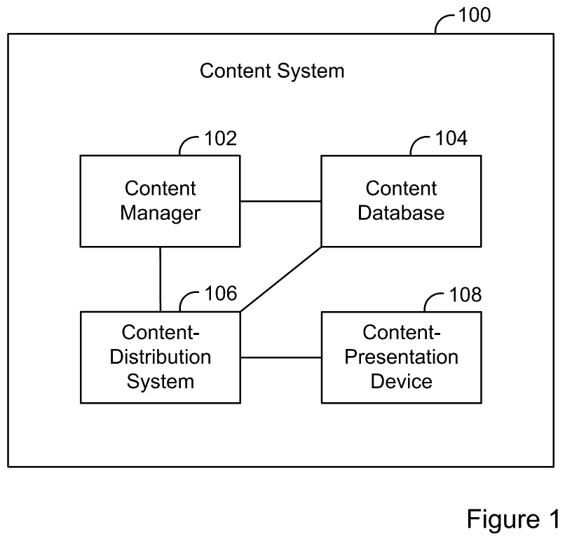

FIG. 1 is a simplified block diagram of an example content system 100. Generally, the content system 100 can perform operations related to various types of content, such as media content, which can take the form of video content and/or audio content. As noted above, the media content can include a video content component and/or an audio content component. There can be various types of media content. For example, media content can be, or include, a movie, a television show, a commercial or other advertisement content, or a portion or combination thereof, among numerous other possibilities.

Media content can be represented by media data, which can be generated, stored, and/or organized in various ways and according to various formats and/or protocols, using any related techniques now known or later discovered. For example, the media content can be generated by using a camera, a microphone, and/or other equipment to capture or record a live-action event. In another example, the media content can be synthetically generated, such as by using any related media content generation technique now known or later discovered.

As noted above, media data can also be stored and/or organized in various ways. For example, the media data can be stored and organized as a Multimedia Database Management System (MDMS) and/or in various digital file formats, such as the Moving Picture Experts Group 4 (MPEG-4) format, among numerous other possibilities.

The media data can represent the media content by specifying various properties of the media content, such as video properties (e.g., luminance, brightness, and/or chrominance values), audio properties, and/or derivatives thereof. In some instances, the media data can be used to generate the represented media content. But in other instances, the media data can be a fingerprint or signature of the media content, which represents the media content and/or certain characteristics of the media content, and which can be used for various purposes (e.g., to identify the media content or characteristics thereof), but is not sufficient at least on its own to generate the represented media content.

Video content and/or audio content may also be represented by video data and/or audio data, in a similar fashion as above with regards to media data. For example, video data may include at least a portion of the video content and/or a representation of the video content, such as video properties (e.g., luminance, brightness, and/or chrominance values) and/or derivatives thereof. In some instances, video data may include data generated based on at least a portion of the video content, such as data generated from a trained machine-learning model based on at least a portion of the video content. This generated data may then be used for further purposes, as described below.

In some instances, media content can include metadata associated with the video and/or audio content. In the case where the media content includes video content and audio content, the audio content is generally intended to be presented in sync with the video content. To help facilitate this, the media data can include metadata that associates portions of the video content with corresponding portions of the audio content. For example, the metadata can associate a given frame or frames of video content with a corresponding portion of audio content. In some cases, audio content can be organized into one or more different channels or tracks, each of which can be selectively turned on or off, or otherwise controlled. There can also be other types of metadata, such as metadata related to an aspect ratio or resolution of video content, or other metadata, such as those types described throughout this disclosure.

In some instances, media content can be made up of one or more segments. For example, in the case where the media content is a movie, the media content may be made up of multiple segments, each representing a scene (or perhaps multiple scenes) of the movie. As another example, in the case where the media content is a television show, the media content may be made up of multiple segments, each representing a different act (or perhaps multiple acts) of the show. In various examples, a segment can be a smaller or larger portion of the media content. For instance, a segment can be a portion of one scene, or a portion of one act. In another example, a segment can be multiple scenes or multiple acts, or various portions thereof.

Returning back to the content system 100, this can include various components, such as a content manager 102, a content database 104, a content-distribution system 106, and a content-presentation device 108. The content system 100 can also include one or more connection mechanisms that connect various components within the content system 100. For example, the content system 100 can include the connection mechanisms represented by lines connecting components of the content system 100, as shown in FIG. 1.

In this disclosure, the term “connection mechanism” means a mechanism that connects and facilitates communication between two or more components, devices, systems, or other entities. A connection mechanism can be or include a relatively simple mechanism, such as a cable or system bus, and/or a relatively complex mechanism, such as a packet-based communication network (e.g., the Internet). In some instances, a connection mechanism can be or include a non-tangible medium, such as in the case where the connection is at least partially wireless. In this disclosure, a connection can be a direct connection or an indirect connection, the latter being a connection that passes through and/or traverses one or more entities, such as a router, switcher, or other network device. Likewise, in this disclosure, a communication (e.g., a transmission or receipt of data) can be a direct or indirect communication.

In some instances, the content system 100 can include multiple instances of at least some of the described components. The content system 100 and/or components thereof can take the form of a computing system, an example of which is described below.

### B. Computing System

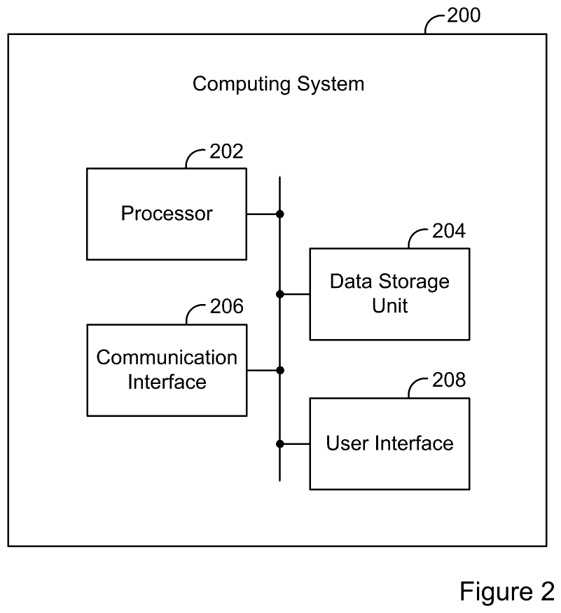

FIG. 2 is a simplified block diagram of an example computing system 200. The computing system 200 can be configured to perform and/or can perform various operations, such as the operations described in this disclosure. The computing system 200 can include various components, such as: a processor 202, a data storage unit 204, a communication interface 206, and/or a user interface 208.

The processor 202 can be, or include, a general-purpose processor (e.g., a microprocessor) and/or a special-purpose processor (e.g., a digital signal processor). The processor 202 can execute program instructions included in the data storage unit 204 as described below.

The data storage unit 204 can be or include one or more volatile, non-volatile, removable, and/or non-removable storage components, such as magnetic, optical, and/or flash storage, and/or can be integrated in whole or in part with the processor 202. Further, the data storage unit 204 can be, or include, a non-transitory computer-readable storage medium, having stored thereon program instructions (e.g., compiled or non-compiled program logic and/or machine code) that, upon execution by the processor 202, cause the computing system 200 and/or another computing system to perform one or more operations, such as the operations described in this disclosure. These program instructions can define, and/or be part of, a discrete software application.

In some instances, the computing system 200 can execute program instructions in response to receiving an input, such as an input received via the communication interface 206 and/or the user interface 208. The data storage unit 204 can also store other data, such as any of the data described in this disclosure.

The communication interface 206 can allow the computing system 200 to connect with and/or communicate with another entity according to one or more protocols. Therefore, the computing system 200 can transmit data to, and/or receive data from, one or more other entities according to one or more protocols. In one example, the communication interface 206 can be or include a wired interface, such as an Ethernet interface or a High-Definition Multimedia Interface (HDMI). In another example, the communication interface 206 can be or include a wireless interface, such as a cellular or Wi-Fi interface.

The user interface 208 can allow for interaction between the computing system 200 and a user of the computing system 200. As such, the user interface 208 can be or include an input component such as: a keyboard, a mouse, a remote controller, a microphone, and/or a touch-sensitive panel. The user interface 208 can also be or include an output component such as a display screen (which, for example, can be combined with a touch-sensitive panel), one or more projectors (e.g., for projecting supplemental video content, as described in greater detail below), and/or a sound speaker. The display screen can have a display area (where video content can be displayed), and that display area can have an aspect ratio.

The computing system 200 can also include one or more connection mechanisms that connect various components within the computing system 200. For example, the computing system 200 can include the connection mechanisms represented by lines that connect components of the computing system 200, as shown in FIG. 2.

The computing system 200 can include one or more of the above-described components and can be configured or arranged in various ways. For example, the computing system 200 can be configured as a server and/or a client (or perhaps a cluster of servers and/or a cluster of clients) operating in one or more server-client type arrangements, such as a partially or fully cloud-based arrangement, for instance.

As noted above, the content system 100 and/or components of the content system 100 can take the form of a computing system, such as the computing system 200. In some cases, some or all of these entities can take the form of a more specific type of computing system, such as: a desktop or workstation computer, a laptop, a tablet, a mobile phone, a television, a set-top box, a streaming media device, and/or a head-mountable display device (e.g., virtual-reality headset or an augmented-reality headset), among numerous other possibilities.

### III. Example Operations

The content system 100, the computing system 200, and/or components of either can be configured to perform and/or can perform various operations. As noted above, the content system 100 can perform operations related to media content. But the content system 100 can also perform other operations. Various example operations that the content system 100 can perform, and related features, will now be described with reference to select figures.

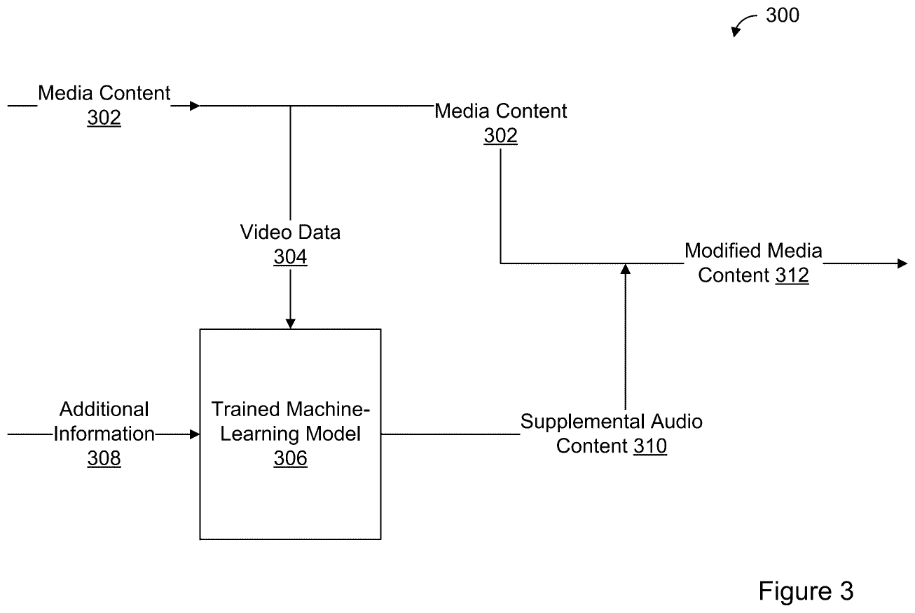

FIG. 3 illustrates an example process and data flow 300 that may relate to the content system 100. While the following disclosure describes the content manager 102 as performing such operations by way of an example, the operations may also be performed by the content-distribution system 106, content-presentation device 108, or any other computing system.

In one aspect, the content manager 102 can obtain media content 302 from the content database 104. Media content, as discussed above, may include video content and audio content.

The content manager 102 may also receive, identify, generate, or otherwise obtain video data 304 associated with the video content. In one example, the video data can be data that represents that video content 304. In another example, video data 304 can include one or more segments of the video content, as described above, and/or one or more portions of the video content. In some situations, video data 304 may include data generated based on at least a portion of the video content. For example, video content may be provided to a trained machine-learning model, and such a model may generate output information regarding the video content, such as metadata, scene context information, video context content information, text data that describes or otherwise relates to the video content, or other information. This information may, in some contexts, indicate or describe an event (e.g., a car driving, glass breaking, etc.) depicted by the video content.

Following this, the content manager 102 may provide the video data 304 to a trained machine-learning model 306, which may employ one or more artificial intelligence, generative artificial intelligence, or machine-learning techniques now know or later discovered. For example, the model may employ an audio content generation model that has been trained using a neural network. Such a neural network may be a convolutional neural network, a deep neural network, a recurrent neural network, and/or any other type of neural network known now or later discovered. The trained machine-learning model 306 may use at least the video data to generate supplemental audio content 310. In some situations, the generation of supplemental audio content 310 (and its subsequent addition into the media content, as discussed below) may occur as a pre-processing step, well before the corresponding media content 302 is presented. However, in some situations, the generation of supplemental audio content 310 and its subsequent addition into the media content may occur in real-time or close to real time, making use of a buffer, such that received media content can be processed and modified near in time before being presented.

The trained machine-learning model 306 can use the video data 304 and/or additional information 308 to generate supplemental audio content 310. For example, the trained machine-learning model 306, upon receiving video data relating to an action movie with a car chase scene, may generate supplemental audio content 310 that may include additional gunshots, engine superchargers, tire screeches, etc. As another example, the trained machine-learning model 306, upon receiving video data relating to a nature documentary, may generate supplemental audio content 310 that may include additional sounds of nature, such as birdsong, rustling leaves, etc., based on the specific events being depicted by the video content. This supplemental audio content 310 may thus have the effect of creating a more immersive experience for the viewer.

Additional information 308 may include information or data associated with the video data 304 and/or media content 302 (and thus the video content and audio content components). For example, additional information 308 can include metadata associated with the video content. This can help ensure that the trained machine-learning model 306 generates supplemental audio content 310 that is contextually relevant to the media content, especially the video content. There could be various types of metadata that the content manager 102 can obtain from various sources. For example, the metadata can relate to scene context information. In some situations, metadata may include genre information, media type, video format, and/or audio format.

The content manager 102 can obtain scene context information from the content database 104 or elsewhere, and can do in various ways. For example, for given media and/or video content, the content manager 102 can (i) obtain closed-captioning text (e.g., which the content manager 102 can extract from metadata associated with the media and/or video content), (ii) subtitle text (e.g., which the content manager 102 can obtain by providing the media and/or video content to an optical character recognition (OCR) system and responsively receiving the subtitle text), (iii) dialogue text (e.g., which the content manager 102 can obtain by providing an audio component of the media content to a speech-to-text (STT) system and responsively receiving the dialogue text), (iv) a text description of an object (e.g., which content manager 102 can obtain by providing the media and/or video content to an object detection system and responsively receiving the text description of the object), and/or (v) a text description of a segment or portion (e.g., which content manager 102 can obtain by providing the media and/or video content to a semantic understanding/description system and responsively receiving the text description of the segment), among numerous other possibilities. For these purposes, the content manager 102 can use any OCR system, STT system, object detection system, and/or semantic understanding/description system, now known or later discovered.

In other examples, the content manager 102 can obtain scene context information, or more generally, video content context information, by extracting it as metadata stored in connection with the media and/or video content and/or a portion thereof, or by obtaining it from an external source, such as an online media content database, for example. Such scene context information or video content context information can include or relate to plot or synopsis text, set location information, identifies of associated actors, producers or other relevant parties, camera settings, color profiles or other cinematography-related attributes, an indication of a scene being considered key shots, and/or an indication of a frame being a first or last frame of scene, among numerous other possibilities that might help the trained machine-learning model 306 generate contextually relevant and/or user-personalized supplemental audio content.

The content manager 102 can provide to the trained machine-learning model 306, as part of additional information 308, text data that describes or otherwise relates to the media content 302 (e.g., for a Western movie, text that describes the video content generally as being a Western-style movie, or that describes the given scene as taking place in a saloon, etc.). This can help the trained machine-learning model 306 generate contextually relevant supplemental audio content. For example, a scene in a desert in a Western may include supplemental audio content 310 including the classic bird screech, or whining sound of the sun at high noon, or the rustle of a rattlesnake, all of which may serve to further immerse the viewer in the media content.

Additionally or alternatively, the additional information 308 can include profile data associated with a user of the content-presentation device 108. This can help ensure that the model generates supplemental audio content that is personalized to the user and/or that aligns with one or more targeted advertising goals.

For example, in the case where the content manager 102 determines that user profile data indicates the user has a preference for or interest in a certain actor/actress, this user profile data can help cause the model to generate supplemental audio content that relates to that actor/actress, for example, their distinct voice in the background.

There can be various types of user profile data that can be obtained/used in this context. For example, the user profile data can include demographic data that provides details about the user's age, gender, etc. As another example, the user profile data can include preference data that indicates content-related preferences for that user. For example, the user preference data could include genre preference data that indicates one or more genre types (e.g., action, adventure, comedy, or romance) that the user prefers. As another example, as noted above, the preference data could include actor/actress preference data that indicates one or more actors or actresses that the user prefers. There can be many other types of preference data as well, including preference data related to any aspect of media (e.g., preferences related to plot types, writers, directors, settings, art styles, release dates, budgets, ratings, and/or reviews, among numbers possibilities).

A particular example of user preference data may include fan allegiance for sports media content. For example, to better immerse a viewer in a broadcast or stream of, for example, a football game between the Chicago Bears and the Detroit Lions, user preference data may indicate which team the viewer is a fan of. This indication may be made in various ways, such as based on viewing history, location, etc. If the viewer is a fan of the Chicago Bears, and the game is played at the home field of the Detroit Lions, the media content may be focused towards fan noise (e.g., cheers, etc.) of the home team. However, the user preference data may be used by the trained machine-learning model 306 to create user-personalized supplemental audio content 310. Following the football example, the user-personalized supplemental audio content 310 could be “Go Bears!” or “Bear Down!” cheers in the background of the media content, to better immerse the viewer and to create a better fan experience for non-home team viewers of sports media content.

Preference data can be represented in various ways. For instance, preference data can be represented with one or more scores (e.g., from 0-100) being assigned to each of multiple different potential preferences to indicate a degree or confidence score of each one, with 0 being the lowest and 100 being the highest, as just one example. For instance, in the case where the preference data indicates genre type preferences, the preference data could indicate a score of 96 for action, a score of 82 for adventure, a score of 3 for comedy, a score of 18 for romance, and so on. As such, the score of 96 for action can indicate that the user generally has a strong preference for media content of the action genre. Similarly, the score of 82 for adventure can indicate that the user also generally has a strong preference for media content of the adventure genre, though not quite as strong as a preference as compared to the action genre. And so on for each of the other genres. This sort of information, when included in the additional information 308 may help the trained machine-learning model 306 generate contextually relevant and/or user-personalized supplemental audio content.

There can be other types of user profile data as well. For example, user profile data can include content presentation history information of the user, among numerous other possibilities. In some instances, content presentation history information could indicate various user activity in connection with media content and/or portions thereof. For example, user profile data could indicate which movies, television shows, or advertisements a user has watched, how often, etc. In another example, user profile data could indicate an extent to which the user has replayed or paused certain media, or a segment thereof, which might indicate a certain level of interest in that portion. In another example, user profile data can include an emotional response profile for that user.

User activity data can be collected on an aggregate level as well. For example, if many viewers of a certain type of media content turn up the volume level at a certain part of media content, that may indicate that many viewers are having trouble hearing the audio content at that part. As another example, if many viewers of a certain type of media content turn on closed captions at a certain part of media content, that may indicate that many viewers are having trouble hearing at that part. This information may be represented as aggregate indicators, and may be collected and/or stored in connection with the content database 104. Consequently, in response to either of these indications, the content manager 102 may purposefully not generate supplemental audio content 310 for that particular piece of media content, so as to not overwhelm a user with too much audio or more audio than a viewer might be able to handle or process.

In another example, user profile data can include annotations made by the user in connection with a given segment of media content. In one aspect, while a user is viewing media content via the content-presentation device 108, the user can use a user interface of the content-presentation device 108 to annotate the media content, such as by marking a specific temporal portion of the media content (e.g., with starting frame and ending frame markers) or by adding corresponding notes (e.g., by entering text, adding a voice-based note, etc.). This annotation data can then be stored as metadata and later obtained for use in connection with the techniques described herein and/or for various other purposes.

Such user profile data can be obtained, stored, organized, and retrieved in various ways, such as by using any related user profile data technique now known or later discovered. In some instances, user profile data can be obtained, stored, and/or used only after the user has provided explicit permission for such operations to be performed. Likewise, in some cases, various other features and/or operations disclosed herein can be provided/performed only after the user has provided explicit permission to do so. Notably, user profile data can also be used to store user settings for various configurations (e.g., to enable or disable one or more features, such as those disclosed herein).

Additionally or alternatively, the additional information 308 can include hardware characteristic data associated with hardware for presenting the media content. Hardware characteristic data may be associated with the content-presentation device 108 or other devices, systems, or other hardware used for presenting content. Such hardware may include streaming devices, DVD and/or Blu-ray players, televisions, projectors, audio-video receivers, audio speakers, soundbars, sound systems, etc. For example, hardware characteristic data associated with audio speakers may include the impedance and/or frequency range of the audio speakers. This sort of information may help the trained machine-learning model 306 generate supplemental audio content 310 that takes advantage of the technical capabilities of the hardware used for presenting the media content. As another example, hardware characteristic data may indicate the number of audio channels (e.g., two, five, seven, etc.) that an audio-video receiver and/or sound system is capable of supporting, and thus this may also help the trained machine-learning model 306 generate supplemental audio content 310 in accordance with the technical capabilities of the hardware.

Additionally or alternatively, the additional information 308 can include subtitle or closed-captioning data associated with the media content. The subtitles or closed captions may indicate certain aspects of the media content that may be useful in connection with the trained machine-learning model 306 generating contextually relevant and/or user-personalized supplemental audio content.

Along the above lines, the trained machine-learning model 306 may generate supplemental audio content in a different language from that of the audio content of the received media content. For example, if a film is in a foreign language with English subtitles, and a user prefers or only understands English, the trained machine-learning model 306 may use the English subtitles as a basis to generate English dialogue audio that may be dubbed over and/or replace the original audio dialogue track. This may result in audio content that is more immersive and better understood by the user.

Additionally or alternatively, the additional information 308 can include still other types of data, such as previous outputs of previous iterations of using the trained machine-learning model 306 (in connection with other portions of the media content, or for related media content). This can help ensure that the trained machine-learning model 306 generates output that is consistent with previously generated output. In practice this can help ensure that there is consistency among supplemental audio content generated over a given time period, such as in connection with a given segment of media content. To accomplish this, the content manager 102 may create and/or store media content generation templates that may contain additional information used for different types of content. For example, if the content manager 102 detects that the media content 302 relates to sports, it may select a media content generation template specific to sports (for example, specifying the team-specific cheering example given above). In some situations, the content manager 102 may select a media content generation template based on metadata associated with the media content.

In this context, other examples include specifying the types of sounds used for different genres of movies—thus, action movies could have a media content generation template, and nature documentaries could have another. Templates of this sort allow for more efficient generation of supplemental audio content 310 by the trained machine-learning model 306, and can, as described above, help ensure that there is consistency among supplemental audio content generated over a given time period, such as in connection with a given segment, genre, or type of media content.

It should be noted that the above-described examples of items that may be included in additional information 308 and provided to the trained machine-learning model 306 are provided as examples, and are not meant to be limiting. Other types of information and/or data may be included in additional information 308 as appropriate to suit a described configuration.

After the trained machine-learning model 306 generates the supplemental audio, the content manager 102 can modify the media content 302 by at least adding the supplemental audio content 310 to the media content 302. Alternatively, the content manager 102 can combine the original audio content and the supplemental audio content, thereby creating combined audio content. The content manager 102 can then replace the original audio content with the combined audio content. In some situations, the supplemental audio content 310 may have the same audio format as the original audio content of the media content 302, though in some situations the audio format may differ.

In some situations, the content manager 102 can provide the supplemental audio content 310 to a further trained machine-learning model, which may then generate subtitle data or closed-captioning data representative of the supplemental audio content. The content manager 102 can then receive the generated subtitle or closed-captioning data from the model, and can associate it with the modified media content 312 (e.g., by including the new subtitles in the media content, or by associating the closed-captioning data with the media content).

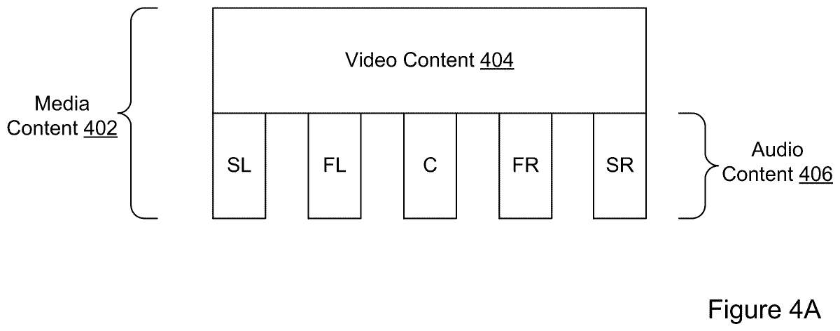

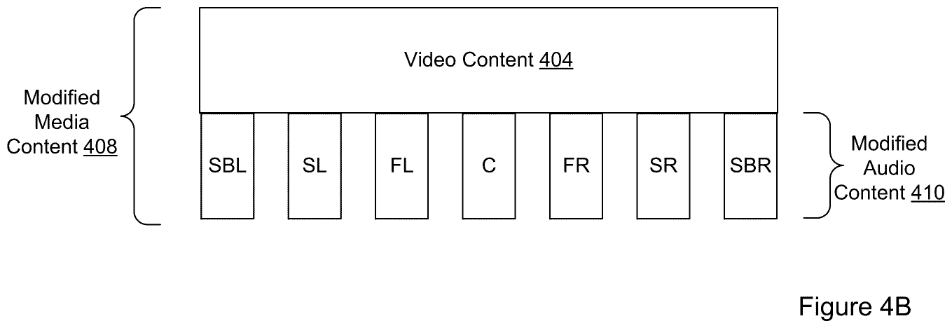

FIGS. 4A and 4B help illustrate the operation of adding supplemental audio content into media content. FIG. 4A depicts media content 402, which includes video content 404 and audio content 406. In the example of FIG. 4A, the audio content 406 has five channels for surround sound: surround left (SL), left (L), center (C), right (R), and surround right (SR).

FIG. 4B depicts modified media content 408, which has been modified in accordance with the process 300 depicted in FIG. 3, and has had supplemental audio content generated and added to the modified media content 408. In this example, the video content 404 of the original media content 402 remains in the modified media content 408, but the audio content 406 has been modified and become modified audio content 410. In this example, the supplemental audio content has been added in the form of two new audio channels, creating a seven-channel surround sound audio track where there were previously five channels. The modified audio content 410 has seven channels: surround back left (SBL), surround left (SL), left (L), center (C), right (R), surround right (SR), and surround back right (SBR). Thus, in some situations, the modified media content may have a different number of audio channels from the original media content.

The addition of channels is just one possibility for the addition of supplemental audio content. In some situations, the supplemental audio content may be added to the existing audio channels. This audio content may then be mixed into a smaller number of audio channels. For example, modern headphones, despite only having two nominal channels (stereo), can virtualize additional channels within the stereo track such that, to the listener, the audio sounds like surround sound. Other audio mixing and combination options are possible in other situations.

Following the addition of the supplemental audio content, the modified media content may then be presented via the content-presentation device 108 or other suitable device or system to an end user.

With regards to the trained machine-model 306, various different types of models could be used for this purpose, including for example, any audio content generation model now known or later developed. Regardless of the employed model, before the content manager 102 uses a model for this purpose, the content system 100 can first train the model by providing it with training input data sets and training output data sets that parallel the input and output data discussed above in connection with what can be considered the runtime phase, but in a training phase. In some situations, the model may be trained to recognize certain scene attributes to identify the type of content and to generate appropriate corresponding audio content, such as audio content associated with past video content. For example, a model may compare the video content to past video content that it was trained on. Should the video content exceed a threshold extend of similarity, the model may then determine that the video content is of a certain type and proceed to generate appropriate supplemental audio content. As such, the model can be trained in a training phase and then the trained model can be used in a runtime phase, such as in the ways discussed above.

In practice, it is likely that large amounts of training data—perhaps thousands of training data sets or more—would be used to train the model, as this generally helps improve the usefulness of the model. Training data can be generated in various ways, including by being manually assembled. However, in some cases, the one or more tools or techniques, including any training data gathering or organization techniques now known or later discovered, can be used to help automate or at least partially automate the process of assembling training data and/or training the model. For these purposes, the content manager 102 can use any machine learning technique, DNN, and/or model now known or later discovered.

In some cases, existing audio content, with certain editing, can be used as at least part of the training data. For example, the training data could involve a database of stock sounds associated with labels. During training, the model would learn how to associate sounds with the labels, certain aspects of video content, and/or additional information. For example, the model may learn to associate an action movie's car chase scene with engine noises, tire screeches, etc.

Thus, in the runtime phase, after determining the attributes of the video content and/or additional information as discussed above, the model may generate supplemental audio using at least in part the database of stock sounds, particularly sounds associated with the determined attributes. In this way, the content manager 102 can train the model to start with video content, and learn how to generate corresponding supplemental audio content.

The content manager 102 can then transmit the modified media content 302 to the content-distribution system 106, which in turn can transmit the modified media content 302 to the content-presentation device 108, which can receive the modified media content 302 and output it for presentation to an end user.

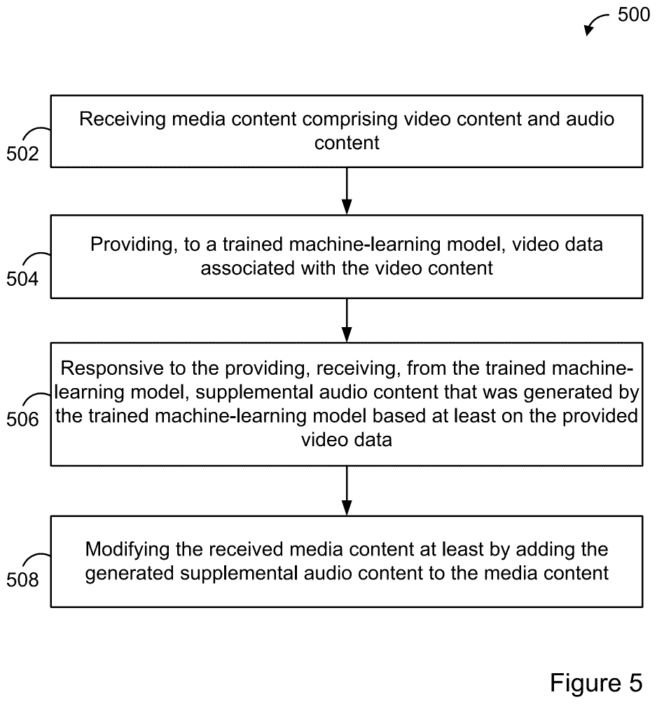

FIG. 5 is a flow chart illustrating an example method 500. The method 500 can be carried out by a content manager, such as the content manager 102, a content-presentation device, such as the content-presentation device 108, or more generally, by a computing system, such as the computing system 200.

At block 502, the method 500 may include receiving media content comprising video content and audio content. At block 504, the method 500 may include providing, to a trained machine-learning model, video data associated with the video content. At block 506, the method 500 may include responsive to the providing, receiving, from the trained machine-learning model, supplemental audio content that was generated by the trained machine-learning model based at least on the provided video data. At block 508, the method 500 may include modifying the received media content at least by adding the generated supplemental audio content to the media content.

In some examples, the method 500 may further include presenting, via a content-presentation device, the modified media content.

In some examples, the video data includes at least a portion of the video content.

In some examples, the video data includes data generated based on at least a portion of the video content. In some examples, the data generated from at least a portion of the video content indicates an event depicted by the video content.

In some examples, the method 500 may further include providing, to the trained machine-learning model, metadata associated with the media content, wherein the supplemental audio content was generated by the trained machine-learning model based at least on (i) the at least a portion of the provided video data and (ii) the metadata associated with the media content. In some examples, the metadata includes at least one of genre, media type, video format, or audio format.

In some examples, the method 500 may further include providing, to the trained machine-learning model, user preference data associated with the media content, wherein the supplemental audio content was generated by the trained machine-learning model based on (i) the at least a portion of the provided video data and (ii) the user preference data associated with the media content.

In some examples, the method 500 may further include providing, to the trained machine-learning model, hardware characteristic data associated with hardware for presenting the media content, wherein the supplemental audio content was generated by the trained machine-learning model based on (i) the at least a portion of the provided video data and (ii) hardware characteristic data associated with hardware for presenting the media content. In some examples, the hardware for presenting the media content includes audio speakers. In some examples, the hardware characteristic data includes at least one of impedance of the audio speakers or frequency range of the audio speakers.

In some examples, modifying the received media content by adding the supplemental audio content to the media content includes: (i) combining the audio content of the received media content with the generated supplemental audio content, thereby generating combined audio content, and (ii) replacing the audio content of the received media content with the generated combined audio content.

In some examples, the method 500 further includes providing, to the trained machine-learning model, subtitle data or closed-captioning data associated with the media content, wherein the supplemental audio content was generated by the trained machine-learning model based at least on (i) the at least a portion of the provided video data and (ii) the subtitle data or closed-captioning data.

In some examples, the supplemental audio content was generated by the trained machine-learning model based at least on (i) the at least a portion of the provided video data and (ii) a media content generation template. In some examples, the media content generation template was selected based on metadata associated with the media content.

In some examples, modifying the received media content by adding the supplemental audio content to the media content includes adding the generated supplemental audio content to the media content as an additional audio channel.

In some examples, the generated supplemental audio content has a different audio format from that of the audio content of the received media content.

In some examples, the generated supplemental audio content has a different audio language from that of the audio content of the received media content.

In some examples, the method 500 further includes providing, to the trained machine-learning model, user activity data associated with the media content, wherein the supplemental audio content was generated by the trained machine-learning model based at least on (i) the at least a portion of the provided video data and (ii) the user activity data associated with the media content. In some examples, the user activity data includes at least one of aggregate indicators of volume levels associated with the media content or aggregate indicators of the use of subtitles or closed-captions associated with the media content.

### IV. Example Variations

Although some of the acts and/or functions described in this disclosure have been described as being performed by a particular entity, the acts and/or functions can be performed by any entity, such as those entities described in this disclosure. Further, although the acts and/or functions have been recited in a particular order, the acts and/or functions need not be performed in the order recited. However, in some instances, it can be desired to perform the acts and/or functions in the order recited. Further, each of the acts and/or functions can be performed responsive to one or more of the other acts and/or functions. Also, not all of the acts and/or functions need to be performed to achieve one or more of the benefits provided by this disclosure, and therefore not all of the acts and/or functions are required.

Although certain variations have been discussed in connection with one or more examples of this disclosure, these variations can also be applied to all of the other examples of this disclosure as well.

Although select examples of this disclosure have been described, alterations and permutations of these examples will be apparent to those of ordinary skill in the art. Other changes, substitutions, and/or alterations are also possible without departing from the invention in its broader aspects as set forth in the following claims.

1. A method comprising:
receiving media content comprising video content and audio content;
providing, to a trained machine-learning model, video data associated with the video content;
responsive to the providing, receiving, from the trained machine-learning model, supplemental audio content that was generated by the trained machine-learning model based at least on the provided video data; and
modifying the received media content at least by adding the generated supplemental audio content to the media content.

2. The method of claim 1, wherein the video data comprises at least a portion of the video content.

3. The method of claim 1, wherein the video data comprises data generated based on at least a portion of the video content.

4. The method of claim 3, wherein the data generated from at least a portion of the video content indicates an event depicted by the video content.

5. The method of claim 1, further comprising:
providing, to the trained machine-learning model, metadata associated with the media content, wherein the supplemental audio content was generated by the trained machine-learning model based at least on (i) the at least a portion of the provided video data and (ii) the metadata associated with the media content.

6. The method of claim 5, wherein the metadata comprises at least one of genre, media type, video format, or audio format.

7. The method of claim 1, further comprising:
providing, to the trained machine-learning model, user preference data associated with the media content, wherein the supplemental audio content was generated by the trained machine-learning model based on (i) the at least a portion of the provided video data and (ii) the user preference data associated with the media content.

8. The method of claim 1, further comprising:
providing, to the trained machine-learning model, hardware characteristic data associated with hardware for presenting the media content, wherein the supplemental audio content was generated by the trained machine-learning model based on (i) the at least a portion of the provided video data and (ii) hardware characteristic data associated with hardware for presenting the media content.

9. The method of claim 8, wherein the hardware for presenting the media content comprises audio speakers, and wherein the hardware characteristic data comprises at least one of impedance of the audio speakers or frequency range of the audio speakers.

10. The method of claim 1, wherein modifying the received media content by adding the supplemental audio content to the media content comprises:
combining the audio content of the received media content with the generated supplemental audio content, thereby generating combined audio content; and
replacing the audio content of the received media content with the generated combined audio content.

11. The method of claim 1, further comprising:
providing, to the trained machine-learning model, subtitle data or closed-captioning data associated with the media content, wherein the supplemental audio content was generated by the trained machine-learning model based at least on (i) the at least a portion of the provided video data and (ii) the subtitle data or closed-captioning data.

12. The method of claim 1,
wherein the supplemental audio content was generated by the trained machine-learning model based at least on (i) the at least a portion of the provided video data and (ii) a media content generation template.

13. The method of claim 12, wherein the media content generation template was selected based on metadata associated with the media content.

14. The method of claim 1, wherein modifying the received media content by adding the supplemental audio content to the media content comprises:
adding the generated supplemental audio content to the media content as an additional audio channel.

15. The method of claim 1, wherein the generated supplemental audio content has a different audio language from that of the audio content of the received media content.

16. The method of claim 1, further comprising:
providing, to the trained machine-learning model, user activity data associated with the media content, wherein the supplemental audio content was generated by the trained machine-learning model based at least on (i) the at least a portion of the provided video data and (ii) the user activity data associated with the media content.

17. The method of claim 16, wherein the user activity data comprises at least one of aggregate indicators of volume levels associated with the media content or aggregate indicators of the use of subtitles or closed-captions associated with the media content.

18. The method of claim 1, further comprising:
presenting, via a content-presentation device, the modified media content.

19. A computing system comprising a processor and a non-transitory computer-readable medium having stored thereon program instructions that upon execution by the processor, cause performance of a set of acts comprising:
receiving media content comprising video content and audio content;
providing, to a trained machine-learning model, video data associated with the video content;
responsive to the providing, receiving, from the trained machine-learning model, supplemental audio content that was generated by the trained machine-learning model based at least on the provided video data; and
modifying the received media content at least by adding the generated supplemental audio content to the media content.

20. A non-transitory computer-readable medium containing thereon program instructions that when executed by a processor cause performance of operations comprising:
receiving media content comprising video content and audio content;
providing, to a trained machine-learning model, video data associated with the video content;
responsive to the providing, receiving, from the trained machine-learning model, supplemental audio content that was generated by the trained machine-learning model based at least on the provided video data; and
modifying the received media content at least by adding the generated supplemental audio content to the media content.
